(19) United States
(12) Patent Application Publication
(10) Pub. No.: US 2015/0281882 A1
(43) Pub. Date: Oct. 1, 2015

(54) SYSTEM AND METHOD FOR TRACKING AND LOCATING USING SOFTWARE APPLICATIONS

(71) Applicant: James S. Tomaszewski, SR., Nashua, NH (US)

(72) Inventor: James S. Tomaszewski, SR., Nashua, NH (US)

(21) Appl. No.: 14/669,174

(22) Filed: Mar. 26, 2015

Related U.S. Application Data
(60) Provisional application No. 61/970,519, filed on Mar. 26, 2014.

(51) Int. Cl. H04W 4/02; G08B 21/24

(52) U.S. Cl. CPC H04W 4/02; G08B 21/24

(57) ABSTRACT

A system and method is configured for tracking and locating a person, pet, or thing to allow pertinent information to be quickly and efficiently communicated, with as little action required of the user as possible, to those in a position to facilitate locating of the person, pet, or thing, since users may be under a great deal of stress because of the inability to locate the person, pet, or thing and be unable to effectively communicate such information.

### RELATED APPLICATIONS

This application claims the benefit of U.S. Provisional Application No. 61/970,519, filed Mar. 26, 2014. This application is herein incorporated by reference in its entirety for all purposes.

### FIELD OF THE INVENTION

The invention relates to systems and methods for assisting a searcher in locating the object of the search, more particularly, to systems and methods for locating a loved one, pet or thing using mobile devices.

### BACKGROUND OF THE INVENTION

Existing systems and methods for locating lost children, pets, elderly loved ones, those with mental illness, and other people, animals, or things for which there is a need to track lack adequate alternative locating methods should the primary locating mechanism fail.

One example of this problem is GPS based locators. GPS can be affected by a number of variables and, generally, must have a clear view of the sky to work properly. Locators based solely on such technology may leave a user anxious and unsure of what steps to take next should the signal be lost.

Another form of tracking involves the use of sensors and security cameras installed in one's home. These systems are capable of alerting a user that someone or something has entered the home safely and some even allow remote monitoring via cameras. Systems such as this do not help when the person, pet, or thing to be tracked does not make it to the home however, again leaving the user anxious, concerned, and unsure of what to do next.

When a tracking system fails and a person, pet or thing to be tracked is not at a scheduled location at a scheduled time, this has a tendency to cause a great deal of anxiety, especially in the case where it is the very young or very old who are missing. This anxiety can make it difficult to recall important details and other information necessary to help locate and safely return the person, pet, or thing. People simply become too focused on what may have happened and are unable to think clearly.

What is needed, therefore, are systems and methods that employ redundant and robust locating mechanisms that are able to be used quickly and easily by an anxious user to facilitate locating a person, pet, or thing.

### SUMMARY OF THE INVENTION

One embodiment of the present invention provides a method for tracking and locating a person, pet, or thing involving fixing a tracking device to a person, pet, or thing to be tracked, recording pertinent information about the person, pet, or thing to be tracked on a computing device, taking a picture of the person, pet, or thing to be tracked and storing the picture and information on the computing device. The user would then create a group of contacts to be contacted in the event that the person, pet, or thing goes missing for a relatively short period of time. These contacts would typically be family, friends, schools, hospitals, veterinarians, coaches, nursing homes and other contacts that may be able to facilitate locating the person, pet, or thing without creating an unnecessary emergency situation and wasting the resources of emergency personnel. The user would then create a second group of contacts that would be contacted in the event that the person, pet, or thing goes missing for a relatively long period of time, when there is more likely to be an emergency situation. Some examples of contacts that a user may add to the second group would be police, amber alert services, etc. In some embodiments, the second group of contacts is generated automatically, based off of the last known location of the person, pet, or thing being tracked. This allows the system to be functional in varied geographic areas without user intervention, increasing the odds of it being useful to the user at a given time. In embodiments, pertinent information includes allergies, medications, eye color, medical information, height, weight and changes in mood or behavior. In still additional embodiments, the stored information also includes the location, date, and time the picture was taken.

Once the initial setup is complete, the user could then track the person, pet, or thing using data sent from the tracking device, as interpreted by a software program installed on the user's computing device. The software program would provide an option to send a picture and the stored information to the first (non-emergency) or second (emergency) groups of contacts for use if the person, pet, or thing being tracked was not able to be located. Using this feature, the user would be able to send all pertinent information with two clicks, assuming they were already within the emergency contact module of the application. The first click to select the group of contacts and the second to send the information to those contacts. This allows even anxious users to reliably send all pertinent information. In embodiments, the tracking device would be able to use cellular data networks to send location and other data to the computing device used to track it.

Embodiments of the present invention use GPS technology to obtain location information. Some embodiments use WiFi to determine location information in the absence of GPS data or to supplement GPS data and increase the accuracy thereof. In embodiments, the tracking device is a mobile phone with embedded GPS. In other embodiments, the tracking device may be located in a collar.

Another embodiment of the present invention allows the user to set a recurring alarm to remind them to take a new picture of the person, pet, or thing to be tracked at a frequency of their choosing. These pictures would also be available for viewing in chronological order on the computing device and could be backed up automatically to a server and hosted on a website or simply backed up to an alternate location of the user's choice. These pictures could also be transformed automatically into a scrapbook using the software, which may even have music added, at the discretion of the user. The pictures could even be used to reflect the appearance of the person, pet or thing at a future date as specified by the user.

A further embodiment of the present invention provides the user the option to take and categorize pictures at any time for addition to their collection. These pictures could be implemented into a scrapbook generated by the application or simply take advantage of the automated backup and categorization features of the software. Some categories may be religious events, birthdays, sporting events, and other memorable events.

A yet further embodiment of the present invention provides geofencing capabilities. These allow the user to set up designated “geofenced” areas for the tracked person, pet, or thing and designate actions to be taken should the person, place, or thing travel outside of said geofenced area. Some actions could include sending a message to the tracking computer or to the first group of contacts generally.

In addition to being useful in an emergency, embodiments of the present invention can provide pertinent information, such as changes in behavior, mood, rashes, injuries, etc. to a primary care physician or other healthcare professional.

Still further embodiments could activate a video camera in the tracking device according to predefined triggers and send the captured video to the computer used to track it when it was within range of a data network.

Embodiments of the present invention also provide a system for tracking and locating a person, pet or thing requiring a tracking device fixed to a person, pet, or thing to be tracked, and a computing device in communication with the tracking device. The computing device must also be capable of sending out an alert containing pertinent information about a tracked person, pet, or thing and a recent photograph of the tracked person, pet, or thing. In typical usage, there would be two groups of contacts. The first group would be contacted shortly after contact with the tracked person, pet, or thing was lost, and would typically be composed of friends, family and others who may have knowledge of the location of the tracked person, pet, or thing. The second group of contacts would typically be emergency personnel who could assist in retrieving the lost person, pet, or thing, but whose resources may be too precious to contact immediately, when it is unlikely the situation rises to the level of a true emergency. Some embodiments also include an option to post a picture of the tracked person, pet, or thing to a virtual bulletin board, which may be especially useful in the case of a lost pet.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a high-level overview of the system configured in accordance with embodiments of the present invention.

FIG. 2 is a flowchart showing high-level details of the use of the system configured in accordance with embodiments of the present invention.

FIG. 3 is a recreation of one portion of a graphical user interface of a software application, running on a computing device, configured in accordance with embodiments of the present invention.

FIG. 4 is a recreation of one portion of a graphical user interface of a software application, running on a computing device, configured in accordance with embodiments of the present invention.

FIG. 5 is a recreation of a notification window, running on a computing device, configured in accordance with embodiments of the present invention.

FIG. 6 is a recreation of one portion of a graphical user interface of a software application, running on a computing device, configured in accordance with embodiments of the present invention.

FIG. 7 is a recreation of one portion of a graphical user interface of a software application, running on a computing device, configured in accordance with embodiments of the present invention.

FIG. 8 is a recreation of one portion of a graphical user interface of a software application, running on a computing device, configured in accordance with embodiments of the present invention.

FIG. 9 is a recreation of one portion of a graphical user interface of an emergency contact message sent by a software application, running on a computing device, configured in accordance with embodiments of the present invention.

FIG. 10 is a recreation of one portion of a graphical user interface of a software application, running on a computing device, configured in accordance with embodiments of the present invention.

### DETAILED DESCRIPTION

Embodiments of the present invention provide methods for tracking and locating a person, pet, or thing involving fixing a tracking device 100 to a person, pet, or thing to be tracked, recording pertinent information about the person, pet, or thing to be tracked on a computing device 105, taking a picture of the person, pet, or thing to be tracked and storing the picture and information on the computing device 105 for later use in locating the person, pet, or thing. The user could then create a group of contacts to be contacted in the event that the person, pet, or thing goes missing for a relatively short period of time. These contacts would typically be family, friends, schools, hospitals, veterinarians, coaches, nursing homes and other contacts that may be able to facilitate locating the person, pet, or thing without creating an unnecessary emergency situation and unnecessarily diverting the finite resources of emergency personnel.

In embodiments, a user could also create a second group of contacts who would be contacted in the event that the person, pet, or thing goes missing for a relatively long period of time, when there is more likely to be an emergency situation. Some examples of contacts that a user may add to the second group would be police, amber alert services, etc. Both groups would receive a pre-prepared message, which may include a picture or pictures and other pertinent information about the lost person, pet or thing, and indicating that the user was attempting to locate them. Embodiments would also allow for additional information to be added to the pre-prepared message prior to sending.

In some embodiments, the second group of contacts will be generated automatically, based on the last known location of the person, pet, or thing being tracked. This allows the system to be functional in varied geographic areas without user intervention, increasing the odds of it being useful to the user in the event of an unexpected emergency situation. Especially useful in the case of a lost pet, an additional option is present in some embodiments allowing posting of a picture and message to a virtual bulletin board for the purposes of soliciting the help of a larger network than would otherwise be possible.

In embodiments, pertinent information includes allergies, medications, eye color, medical information, height, weight and changes in mood or behavior. In still additional embodiments, the stored information also includes the location, date, and time the picture was taken. Some embodiments also include a video camera embedded in the tracking device which is activated according to predefined triggers and sends captured video to an authorized computer when it is within range of a data network capable of transmitting such information.

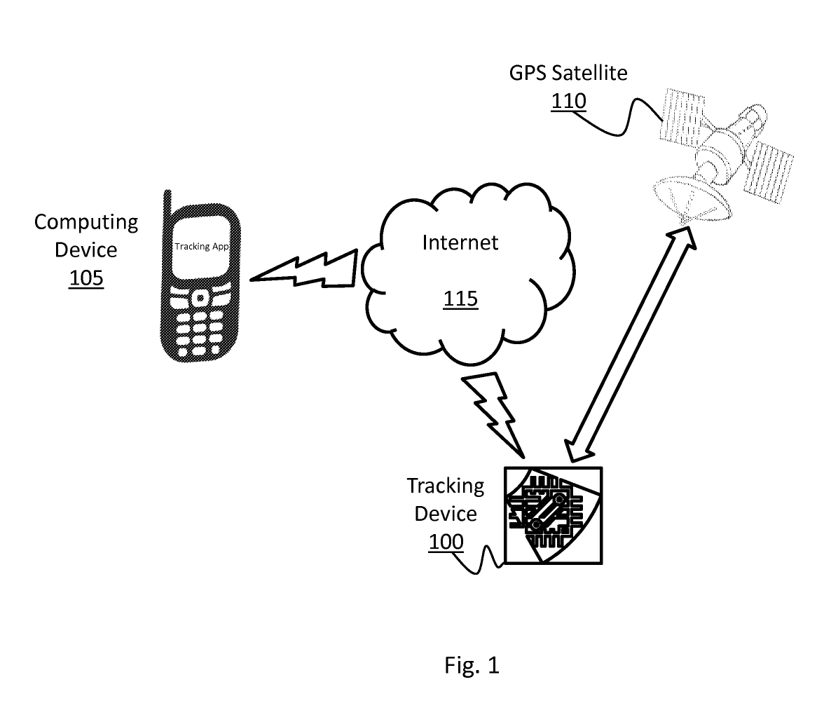

With reference to FIG. 1, a high level overview of one embodiment of the system is shown. This system shows a tracking device 100 in communication with a GPS satellite 110 and a computing device 105 with the appropriate software. The devices are connected through the internet 115 to enable transmittal of location and, in embodiments, additional information, such as photographs and video, between the tracking device 100 and the computing device 105. One skilled in the art will note that there are numerous ways to connect to the internet, such as satellite links, WiFi, cellular networks, cable, DSL, dialup, and many more. The appropriateness of a connection medium for a given usage scenario will dictate which is used in a given situation. It should further be noted that, although GPS data is contemplated as the primary way to obtain location information, the data connection medium or other sources may offer alternative ways to obtain tracking information independently for comparison, backup, or as a supplement to the primary location information, increasing its accuracy. One such example would be retrieval of location information from WiFi networks to allow for quicker GPS lock times, improved accuracy and tracking ability even when indoors or otherwise without a clear view of the sky.

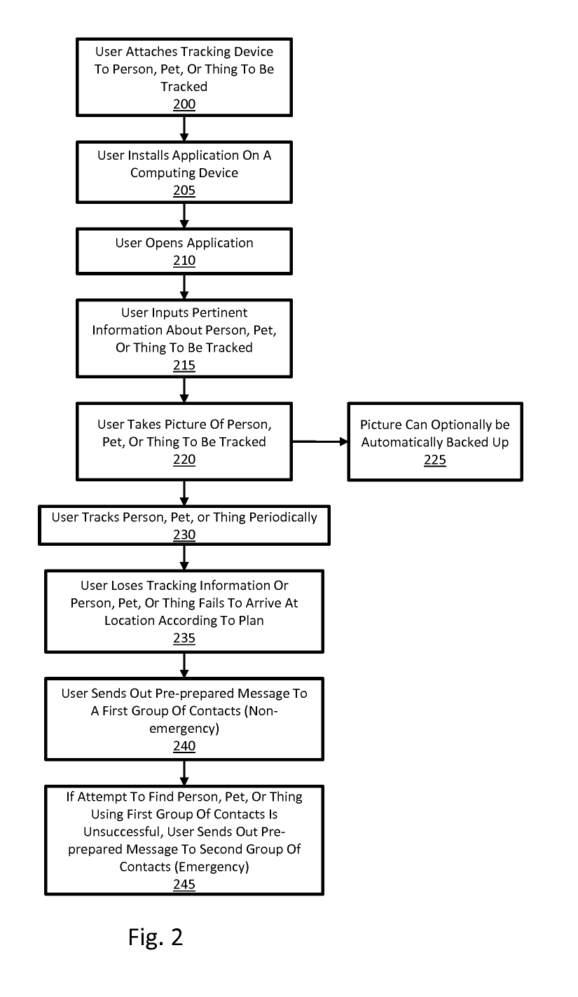

With reference to FIG. 2, a high level overview of the setup and general operation of the tracking software program on a computing device is shown. Initially, the user may attach the tracking device 100 to the person, pet, or thing to be tracked. Attachment may be by adhesive, by integration into a collar or clothing, by instructing the person to be tracked to carry the device, or other means. Adhesive may be appropriate for tracking of objects, while asking a child or elderly person to carry a cellphone for tracking purposes or fixing a tracking collar to a pet may be more appropriate in those situations. Next, the user installs the tracking application on a computing device 105/205. The user may then open the application 210 and enter pertinent information about the person, pet, or thing to be tracked 215. The user would then take a picture of the person, pet or thing to be tracked 220, typically using the computing device 105. This picture, in embodiments, may be automatically backed up to a user's computer or to a remote server 225. In normal usage, the user would then track the person, pet, or thing as desired or necessary 230.

Some embodiments also provide “geofencing” capabilities. Geofencing is the use of location to trigger specific actions. Modification of the triggering locations by variables such as time of the day, week, month or year is also contemplated as within the scope of the current disclosure. Essentially, geofencing as it applies to this disclosure allows the user to set up designated, geofenced, areas for the tracked person, pet, or thing and designate actions to be taken should the person, place, or thing travel outside of said geofenced area or even remain in one area for too long (which may indicate that the tracking device has been lost).

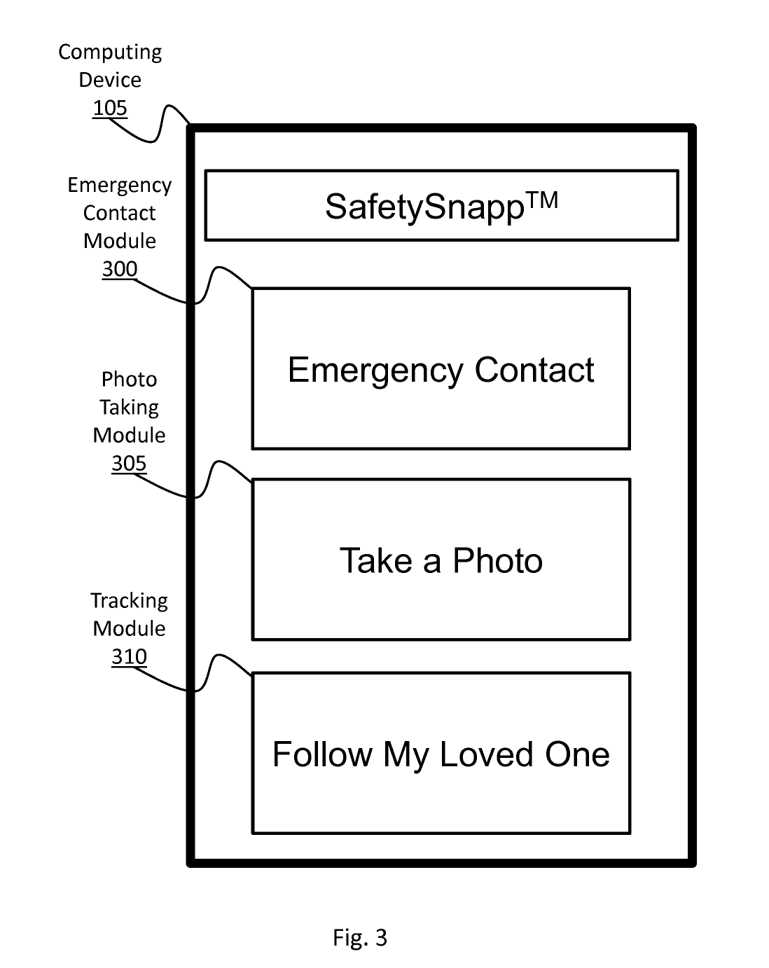

Actions taken in response to a triggering event could include sending a message to the tracking computer or to the first group of contacts generally. These geofences may negate the need to track the subject to learn of their disappearance in many cases. If there are no issues, the user would typically go about their business. If the user loses tracking information, the tracked person is not where they should be, or other circumstances arise that cause the user concern 235 the user would then send out a pre-prepared message to a first group of contacts requesting information as to the tracked person, pet, or thing 240. If the attempt is unsuccessful, after waiting a reasonable amount of time to be contacted, the user could then send out an additional pre-prepared message to a second group of contacts who could deal appropriately with a true emergency 245. Using this feature, the user would be able to send all pertinent information with two clicks, assuming they have already opened the program and have opened the emergency contact module 300, as shown in FIG. 3. The first click selects the group of contacts and the second sends the information to those contacts. This allows even anxious users to reliably send all pertinent information.

With reference to FIG. 3, an embodiment of the application is shown as seen on a computing device 105. On this screen, the emergency contact module 300, photo taking module 305, and tracking module 310 are visible. Although photos are typically taken for the practical purpose of locating the lost person, pet, or thing, embodiments provide the user the option to take and categorize pictures at any time for addition to their collection. These pictures could be implemented into a scrapbook generated by the application or the user could simply take advantage of the automated backup and categorization features of the software. Some categories may be religious events, birthdays, sporting events, and other memorable events, but many others are possible.

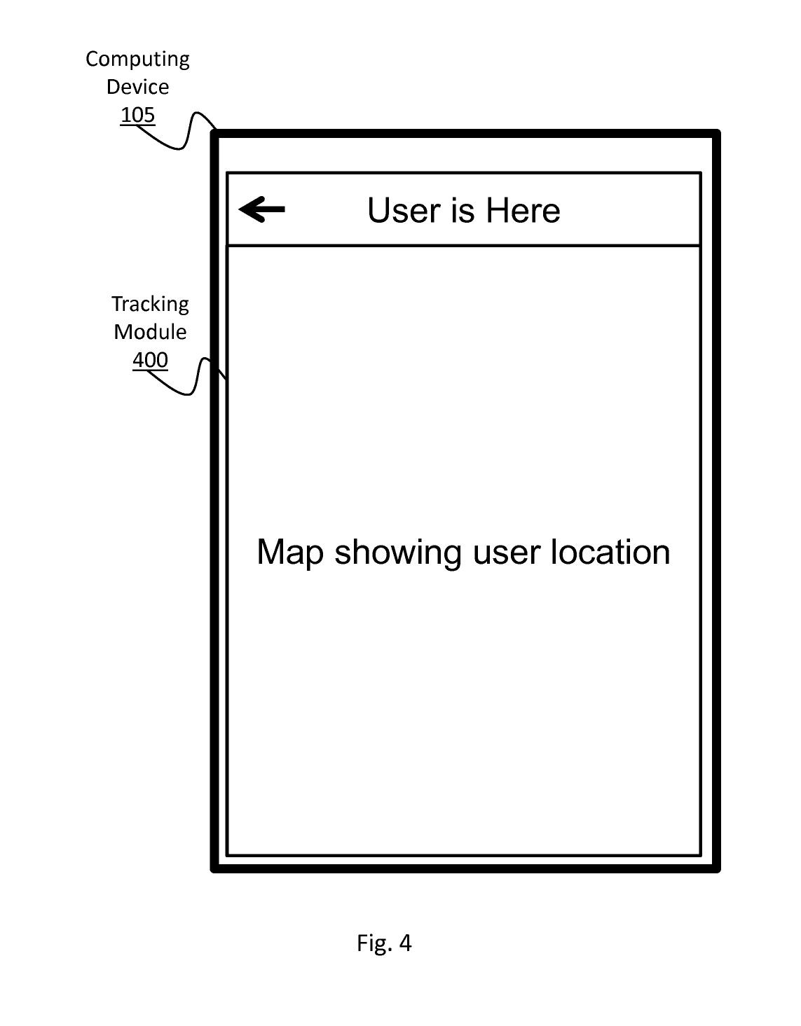

With reference to FIG. 4, an embodiment of the application is shown as seen on a computing device 105. On this screen, the tracking module 400 is shown.

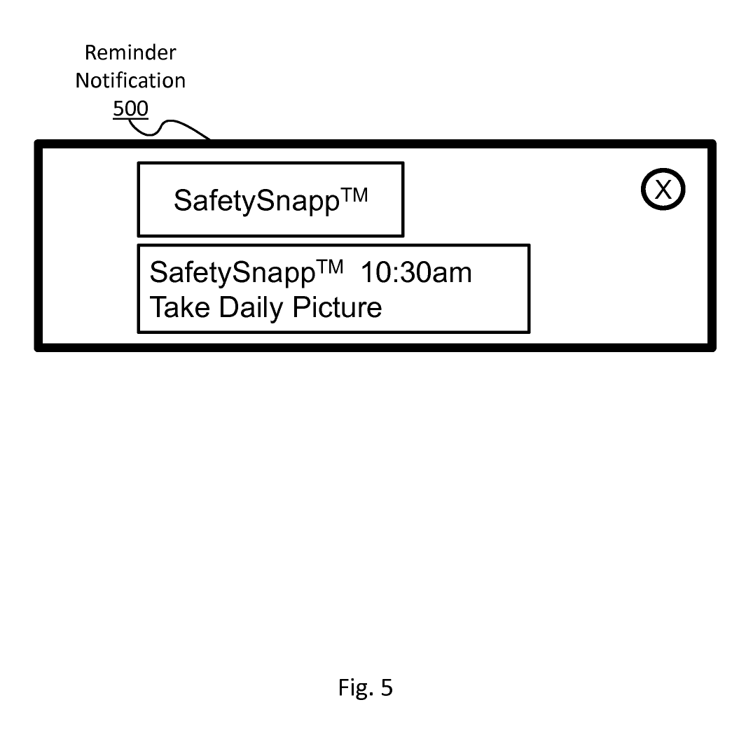

With reference to FIG. 5, a reminder notification 500 is shown as seen on a computing device 105. This reminder notification 500 is set by the user and allows the user to set a recurring alarm to remind them to take a new picture of the person, pet, or thing to be tracked at a frequency of their choosing. These pictures would typically also be available for viewing in chronological or other specified order on the computing device and could be backed up on demand or automatically to a server and hosted on a website or simply backed up to an alternate location of the user's choice.

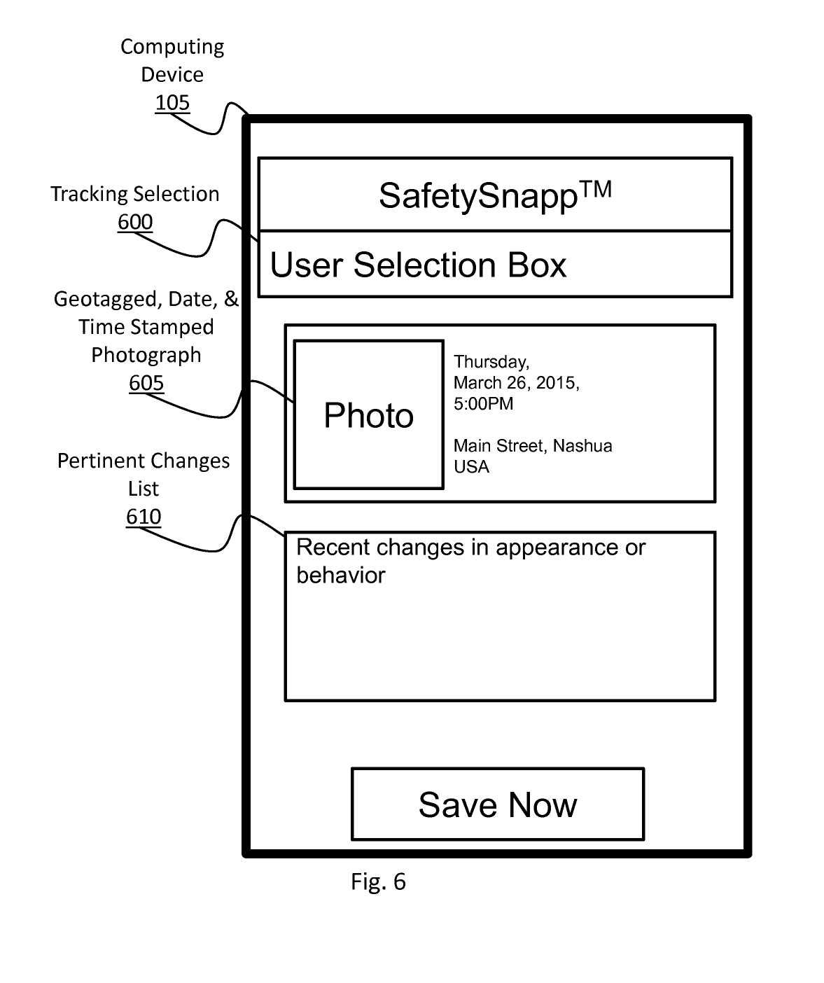

With reference to FIG. 6, an embodiment of the application is shown as seen on a computing device 105. On this screen, the user may choose a subject to track using the tracking selection 600 drop down menu, view information relating to the geotagged, date and time stamped photograph 605 and add information about recent changes in appearance or behavior to a pertinent changes list 610. Additional features in some embodiments allow physicians access to pertinent information that is kept in the regular course of updating the pertinent information stored in the program, such as changes in behavior, mood, rashes, injuries, etc., expanding the utility of the application in non-emergency situations. Such information may be sent from the user device or stored remotely in a database which physicians could request access to.

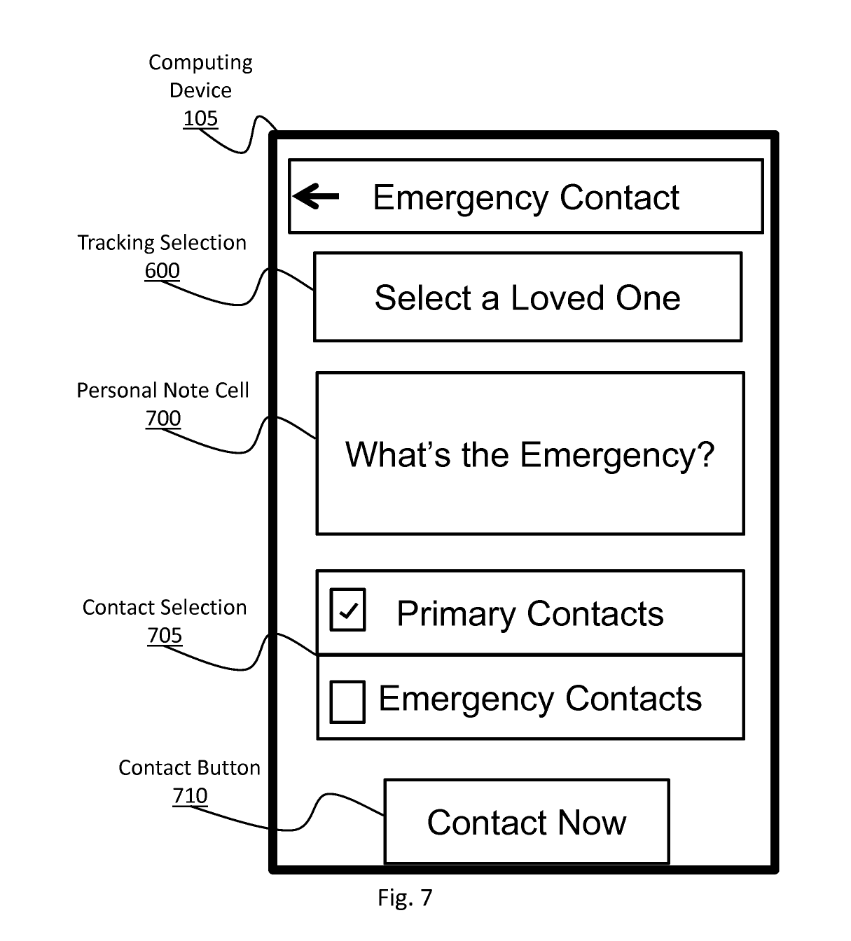

With reference to FIG. 7, an embodiment of the application is shown as seen on a computing device 105. On this screen, the user can choose a tracked person, pet or thing from the tracking selection 600 drop down menu, enter a personal note to be submitted along with the pre-prepared emergency message into the personal note cell 700, select from a first group of contacts (typically non-emergency contacts) or a second group of contacts (typically emergency contacts) using the contact selection 705 check boxes, and send the message as prepared using the contact button 710.

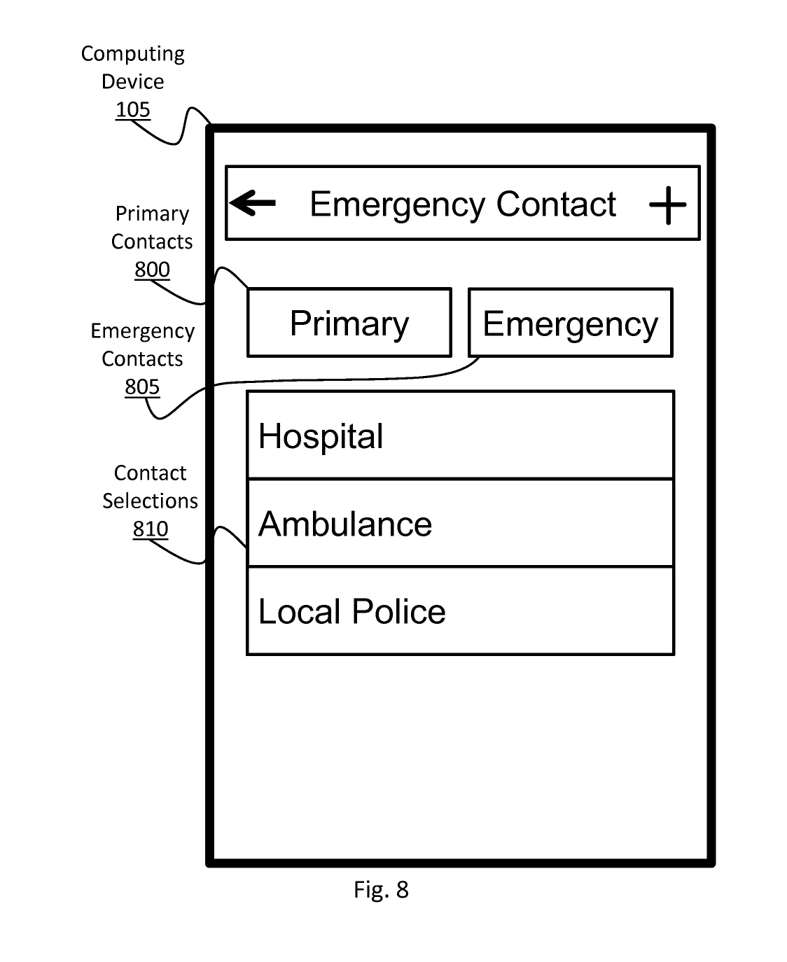

With reference to FIG. 8, an embodiment of the application is shown as seen on a computing device 105. On this screen, the user can choose between primary contacts 800 and emergency contacts 805. The user could further choose a contact using the contact selection 810 portion of the application and edit, or add to, the corresponding information. In embodiments, the emergency contacts are automatically populated, with information obtained from a database, based on the current or last known location of the person, pet, or thing being tracked.

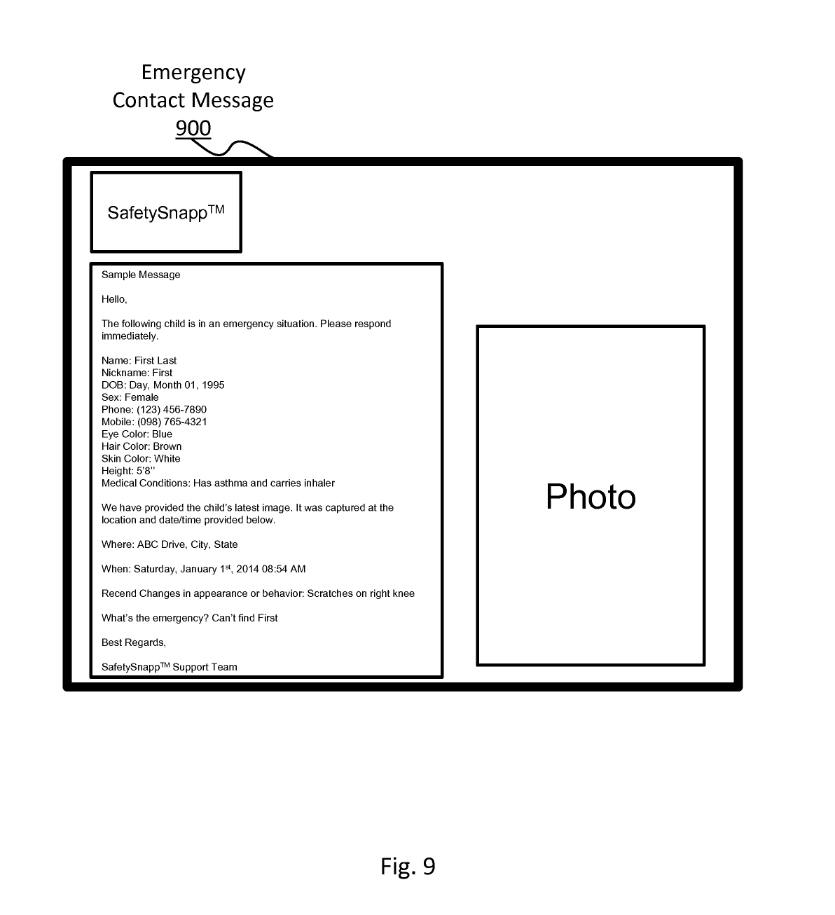

With reference to FIG. 9, the pre-prepared emergency contact message 900 is shown. This message is what would be sent to the primary contacts 800 and emergency contacts 805 in the event the person, pet, or thing being tracked could not be located.

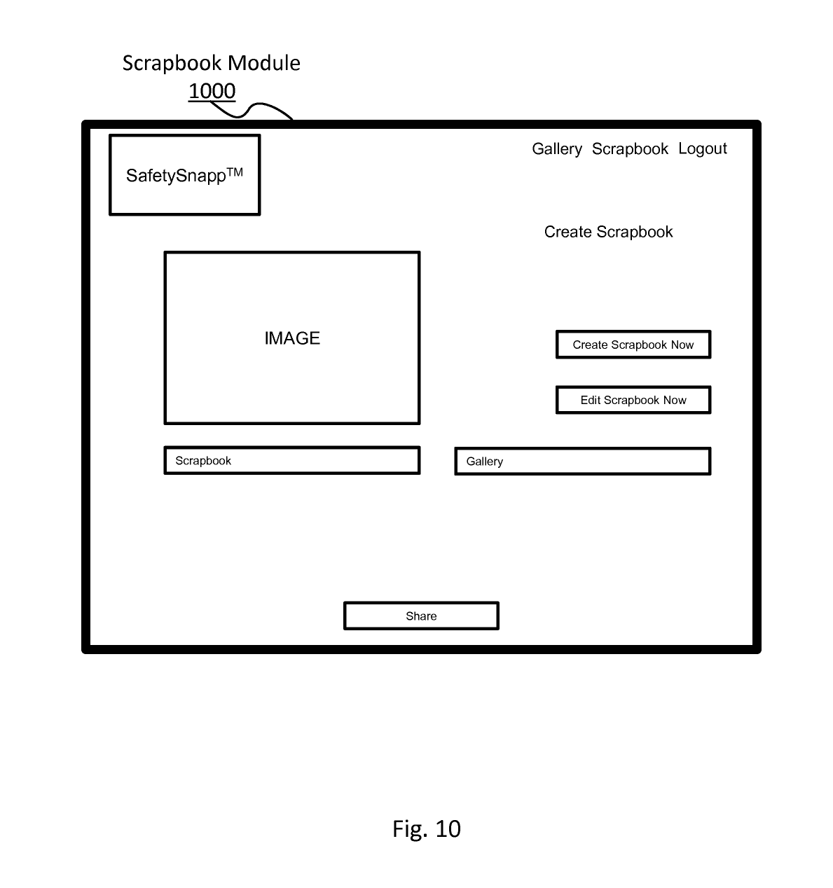

With reference to FIG. 10, a portion of the scrapbook module 1000 is shown. The scrapbook module uses the pictures periodically taken of the tracked person, pet, or thing to automatically create a scrapbook, which may even have music added, at the discretion of the user. The scrapbook creation could also be manually performed by the user with the aid of the scrapbook module 1000. In some embodiments, the pictures could even be used to reflect the appearance of the person, pet or thing at a future date as specified by the user.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

What is claimed is:

1. A method for tracking and locating, the method comprising:
fixing a tracking device to a person, pet, or thing to be tracked;
on a computing device:
recording pertinent information about the person, pet, or thing to be tracked;
taking a picture of the person, pet, or thing to be tracked;
storing said picture and information;
creating a group of contacts to be contacted in the event that the person, pet, or thing goes missing for a relatively short period of time;
creating a second group of contacts to be contacted in the event that the person, pet, or thing goes missing for a relatively long period of time;
tracking the person, pet, or thing using data sent from said tracking device to said computing device;
providing an option to send said picture and stored information to said first and second groups of contacts; and
sending said picture and stored information to said first or second group of contacts dependent on user's choice.

2. The method of claim 1 wherein the second group of contacts is programmatically downloaded from a database, based on the last known location of the person, pet, or thing being tracked.

3. The method of claim 1 further comprising alarming at a time and frequency set by a user to remind the user to take a new picture of the person, pet, or thing to be tracked.

4. The method of claim 3 wherein said pictures are backed up through storage at a remote location, programmatically.

5. The method of claim 4 wherein said pictures are hosted on a website accessible to a user.

6. The method of claim 5 wherein said pictures are programmatically transformed into a scrapbook.

7. The method of claim 6 wherein said scrapbook further comprises programmatically selected music.

8. The method of claim 1 further comprising providing the user an option to programmatically alter said picture or pictures to reflect the predicted appearance of the person, pet or thing at a future date specified by said user.

9. The method of claim 8 wherein said programmatic alteration of said pictures is performed, without user intervention, to the most recently-taken picture to update it to reflect the current appearance of the person, pet or thing prior to sending of the picture and stored information to said first or second group of contacts.

10. The method of claim 1 wherein said tracking device uses cellular data networks to communicate with said computing device.

11. The method of claim 1 wherein said tracking device uses GPS technology to obtain location information.

12. The method of claim 11 wherein said tracking device uses WiFi to determine location information in addition to GPS data.

13. The method of claim 1 wherein said tracking device is a mobile phone with embedded GPS.

14. The method of claim 1 wherein said pertinent information comprises allergies, medications, eye color, medical information, height, weight and recent changes in mood or behavior.

15. The method of claim 1 wherein said stored information further comprises the location, date, and time said picture was taken.

16. The method of claim 1 further comprising setting up a geographic area in which the tracked person, pet, or thing is expected to be and programmatic actions to be taken without further user input should the person, place, or thing travel outside of said geographic area.

17. The method of claim 1 further comprising sending said recorded pertinent information to a primary care physician or other healthcare professional.

18. The method of claim 1 further comprising activating a video camera in said tracking device according to predefined triggers and sending video to said computing device used for tracking said person, pet, or thing when in range of a data network.

19. A system for tracking and locating, the system comprising:
a tracking device fixed to a person, pet, or thing to be tracked;
a computing device in communication with said tracking device, wherein said computing device is in communication with a data network capable of communicating a message, including images, to a plurality of computing devices; and
wherein said computing device is configured to programmatically send out an alert containing recorded information about a tracked person, pet, or thing and a recent photograph of said tracked person, pet, or thing to at least a first and second user-defined group of contacts in response to a user request or predefined trigger, wherein said first user defined group of contacts comprises friends, family and others who may have knowledge of the location of said tracked person, pet, or thing and said second group of contacts comprises emergency personnel who could assist in retrieving the lost person, pet, or thing.

20. The system of claim 19 further comprising an option to post a picture of said tracked person, pet, or thing to a virtual bulletin board.
